(19) United States
(12) Patent Application Publication
(10) Pub. No.: US 2017/0201158 A1
(43) Pub. Date: Jul. 13, 2017

(54) EXHAUST HEAT RECOVERY SYSTEM CONTROL METHOD AND DEVICE

(71) Applicant: LEARTEK PTY LTD, South Australia (AU)

(72) Inventors: Adam LEAR, South Australia (AU); Saiful BARI, South Australia (AU)

(73) Assignee: LEARTEK PTY LTD, South Australia (AU)

(21) Appl. No.: 15/315,305

(22) PCT Filed: May 29, 2015
(86) PCT No.: PCT/AU2015/000328

§ 371 Date: Nov. 30, 2016

(30) Foreign Application Priority Data
May 30, 2014 (AU) 2014902067

(51) Int. Cl. H02K 7/18; F01K 23/10; F01K 23/06; F02G 5/02

(52) U.S. Cl. CPC H02K 7/1823; F02G 5/02; F01K 23/101; F01K 23/065

(57) ABSTRACT

A waste heat recovery system for use with an internal combustion engine, that includes a first heat exchanger and a second heat exchanger; an exhaust conduit for receiving an input of waste exhaust gas flow from the internal combustion engine; a working fluid configured to absorb thermal energy; a heat collecting circuit operatively connected to the first heat exchanger and the second heat exchanger to transfer heat energy from the waste gas exhaust flow to the working fluid. The working fluid is first directed to the second heat exchanger then directed to the first heat exchanger, the first heat exchanger being positioned upstream, with respect to the waste exhaust gas flow, of the second heat exchanger and then to an electrical generation means. The flow of the working fluid is controllable by way of a control module as is the flow of the exhaust gases, in order to optimise both generation of eletrical energy and operation of the engine.

### FIELD OF THE INVENTION

The present invention relates to the field of heat recovery systems and methods, suitable for use with internal combustion (IC) engines that can recover heat from the waste exhaust gas of an IC engine.

### BACKGROUND

Energy recovery systems are known in the art and typically comprise a heat exchange system in which the waste exhaust gas from an IC engine is utilised to convert a working fluid from a liquid to a vapour, wherein the vapour then in turn drives a turbine that is connected to an electrical generator.

Typically however such combined systems are inefficient in terms of capturing the waste exhaust heat from the exhaust gas, leading to lower than expected energy conversion rates.

### OBJECTS OF THE INVENTION

It is an object of the present invention to provide a method of operating an engine, the engine including a heat recovery system that provides an increase in overall efficiency of the system.

It is a further object of the present invention to overcome or at least address the disadvantages and shortcomings of the prior art.

Other objects and advantages of the present invention will become apparent from the following description, taken in connection with the accompanying drawings in which an embodiment of the present invention is described.

### SUMMARY OF THE INVENTION

According to the present invention, although this should not be seen as limiting the invention in any way, there is provided method of operating an engine, the engine including a heat recovery system having:
at least a first heat exchanger and a second heat exchanger;
an exhaust conduit for receiving an input of exhaust gas from an internal combustion engine;
a working fluid configured to absorb thermal energy;
a heat collecting circuit to direct the working fluid into contact with the exterior surface of the tubes of the first and the second heat exchangers;
wherein the working fluid is first directed to the second heat exchanger then directed to the first heat exchanger, the first heat exchanger being positioned upstream (with respect to exhaust flow) of the second heat exchanger; and
a turbine operatively connected to the heat collecting circuit, and operatively connected to an electrical generator,
   the method comprising:
measuring variables of the working fluid configured to absorb thermal energy as it exits the first heat exchanger;
measuring variables of the working fluid configured to absorb thermal energy as it exits the second heat exchanger;
determining, at least in part, via an engine heat recovery algorithm, within an electronic control module, a combination of engine operating variables, turbine operating variables, and energy generated from the electrical generator that corresponds to a predetermined criteria.

A further form of the invention resides in a waste heat recovery system for use with an internal combustion engine, including
at least a first heat exchanger and a second heat exchanger;
an exhaust conduit for receiving an input of waste exhaust gas flow from the internal combustion engine;
a working fluid configured to absorb thermal energy;
a heat collecting circuit operatively connected to the first heat exchanger and the second heat exchanger to transfer heat energy from the waste gas exhaust flow to the working fluid;
wherein the working fluid is first directed to the second heat exchanger then directed to the first heat exchanger, the first heat exchanger being positioned upstream, with respect to the waste exhaust gas flow, of the second heat exchanger; and
a turbine operatively connected to the heat collecting circuit, and operatively connected to an electrical generator,
a working fluid control means to control the flow of working fluid into the second heat exchanger;
the working fluid control valve being operatively connected to a control module, said control module capable of controlling the operation of the working fluid control means in response to a variable of at least one variable of the waste heat recovery system, the internal combustion engine or the electrical generator.

The term “exhaust gas” and “waste exhaust gas” are used interchangeable herein to refer to the exhaust gas produce by the operation of an internal combustion engine.

Operating Parameters

In preference, the engine operating variables are: engine applied load; engine speed; mass flow of air into the engine, fuel-flow rate into the engine, exhaust temperature, and oxygen concentration of the exhaust.

In preference, the variable of the working fluid is at least two: pressure and temperature of the working fluid.

In preference, the predetermined criteria includes fuel economy and amount of energy generated from the energy recovery system.

In preference, the engine heat recovery algorithm includes a map of engine load and speed, and at least the pressure and temperature of the fluid in the heat collecting circuit.

In preference, the exhaust temperature is measured by an exhaust temperature measuring means.

In preference, the location of the exhaust temperature measuring means includes at least one location selected from the group of: before first heat exchanger and second heat exchanger; post first heat exchanger and second heat exchanger; and between first heat exchanger and second heat exchanger.

In preference, the method further includes the step of operatively controlling the flow of the exhaust gas in the heat distributing circuit by fluid control means.

In preference, the exhaust gas control means are flow control valves.

In preference, the method further includes the step of operatively controlling the flow of the working fluid in the heat collecting circuit by fluid control means.

In preference, the working fluid control means are flow control valves.

A further aspect of the invention includes a control system for a waste heat recovery system, the control system including the method as described.

Yet a further aspect of the present invention is a vehicle including a control system as described above.

### BRIEF DESCRIPTION OF THE DRAWINGS

By way of example, an embodiment of the invention is described more fully hereinafter with reference to the accompanying drawings, in which:

FIG. 1 shows a schematic view of the exhaust heat recovery device of the present invention in a first configuration being a series configuration;

FIG. 2 shows a schematic view of the exhaust heat recovery device of the present invention in a second configuration being a parallel configuration.

### DETAILED DESCRIPTION OF THE INVENTION

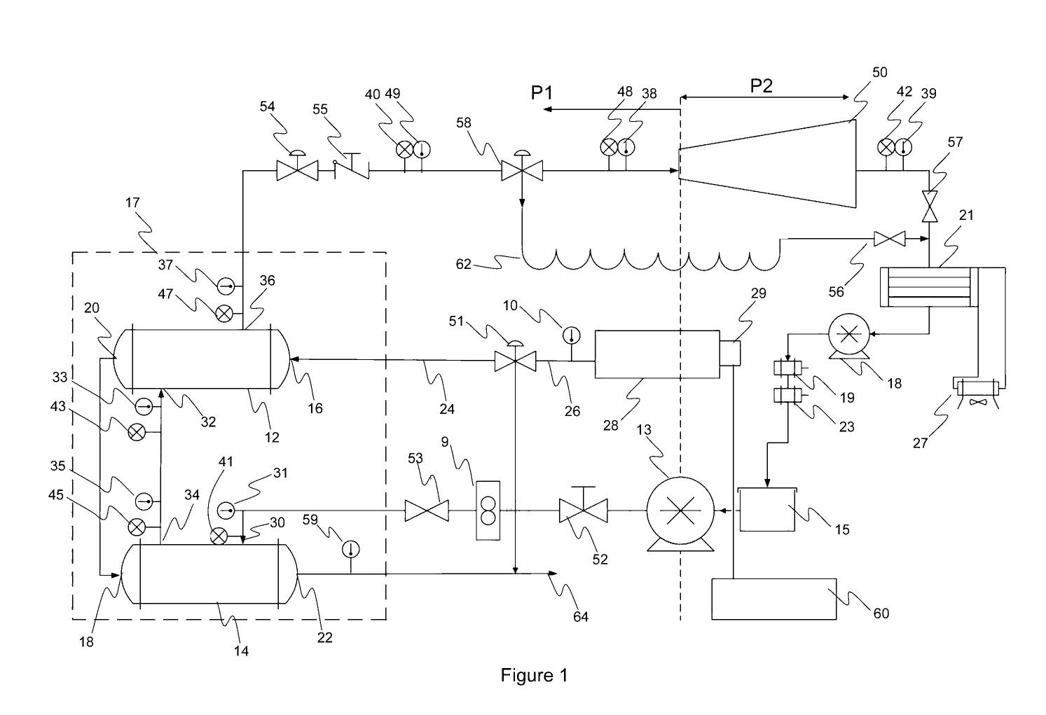

The present invention in FIG. 1 is a series configuration, comprising a first heat exchanger unit (12) and a second heat exchanger unit (14) each of which has an exhaust inlet opening (16 and 18 respectively) and an exhaust outlet opening (20 and 22 respectively). The exhaust outlet (22) leads to the outside environment (64). The exhaust conduit (24) connects an exhaust system (26) of an IC engine (28) to the exhaust inlet opening (16).

The entry of exhaust gases into the heat collecting circuit (17) is controlled by the two-way valve (51), which diverts the exhaust flow out of the system when the IC engine is still in start-up mode. This precaution is taken to limit the amount of particulate matter build-up (fouling) in the heat exchangers from exhaust before the engine is in a stable operating condition. This condition is determined by the control system module using data from the temperature sensing means (10) and the engine load sensor (29).

The heat collecting circuit (17) includes the first (12) and second (14) heat exchangers, each of which has a working fluid inlet opening, (32) and (30) respectively, and a fluid outlet opening, (36) and (34) respectively, to allow a heat absorbing working fluid to pass through. A one-way valve (53) ensures uni-directional flow into the heat collecting circuit (17).

The heat absorbing working fluid is configured or selected so as to be able to readily absorb heat from the exhaust gas. Suitable heat absorbing working fluids include fluids such as water, ammonia, refrigerant gases or mixtures thereof, but are not limited to these.

The engine (28) has a load sensor (29), configured to measure or calculate the load on the engine. Other engine operating variables may also be measured, such as engine temperature, engine speed, exhaust temperature, and oxygen concentration. Various measuring means may be located on the engine in order to provide data on the engine operating variables.

The control system module (60) is operatively connected to the engine load sensing means (29) and is in communication with the temperature sensing means (31) on the second heat exchanger and the temperature sensing means (33) on the first heat exchanger.

The control system module (60) may also be operatively connected to the pump (13) so as to regulate the action of the pump (13) to control the working pressure of the working fluid within the heat collecting circuit (17).

The temperature sensing means, (31) and (33), such as thermocouples, can measure the temperature of the working fluid entering into each of the respective heat exchangers and communicate this information to the control system module (60). Similarly, the pressure sensing means, (41) and (43), such as pressure sensors, can measure the pressure of the working fluid entering into each of the respective heat exchangers and communicate this information to the control system module.

In addition, temperature sensing means, (35) and (37), are positioned or located close to the outlet ports, (34) and (36) respectively, in order to provide temperature data of the working fluid exiting the second and first heat exchangers respectively, and communicating such data to the control system module (60). Similarly, the pressure sensing means, (45) and (47), such as pressure sensors, can measure the pressure of the working fluid exiting each of the respective heat exchangers and communicate this information to the control system module.

A pressure sensor (40) can also be located in the heat recovery system to measure the pressure of the working fluid prior to its passage through the two-way valve (58). In particular, additional pressure sensing means, (48) and (42), may be located immediately before and after the energy generator turbine (50) to measure the pressure or flow of superheated steam through the turbine. Similarly, temperature sensing means, (38) and (39), may be located before and after the energy generator turbine (50) to measure the temperature of superheated steam through the turbine. An overs-peed shut-off valve (55) is closed by the control system module (60) in the event of over-speed of the turbine (50), as detected by sensors integrated into the turbine. A safety valve (54) is opened in the event of pressure build-up in excess a pre-set value.

During operation of the engine (28), the control system module (60) receives engine operating variables data, such as engine load, from the load sensor (29), and exhaust temperature from the exhaust temperature sensor (10), along with working fluid temperature and pressure data from within the fluid circuit, and other engine operating variables. From this data, an optimum working pressure of the working fluid in the heat recovery system and flow rate of the working fluid into the second heat exchanger (14) is determined.

Once the optimum pressure, determined to be that pressure which generates the greatest amount of recovered energy from the turbine (50), is selected then the control system module (60) measures the fluid temperatures via the temperature sensors (35) and (37), said temperatures then being compared with a table of reference temperatures for optimum working pressures by engine mapping.

Those skilled in this particular field would appreciate that a map is a multi-dimensional table of the amount and timing of certain control signals versus required timings, and other known variables such as engine speed, load, and temperature, including other variables.

If the measured temperatures at the temperature sensing means, (35) and (37), are less than the referenced temperatures mapped in the control system module (60), then the control system module (60) operates the valve (52) to decrease the working fluid inlet mass flow rate (as detected by the flow meter (9)) into the second heat exchanger (14).

If the temperature sensing means, (35) and (37), detects that the fluid temperature is greater than the target reference temperature, then the control system module (60) will increase the working fluid inlet mass flow rate (as detected by the flow meter (9)) by opening valve (52). Similarly, if the exhaust temperature is in excess of a pre-set value (as detected by temperature sensing means (59) on the exhaust conduit), then the control system module (60) will increase the working fluid inlet mass flow rate (as detected by the flow meter (9)) by opening valve (52).

If the measured temperature and pressure at the temperature and pressure sensing means, (49) and (40) respectively, are less than the referenced temperatures and pressures mapped in the control system module (60), then the control system module (60) operates the valve (58) to divert some or all of the working fluid around the turbine (50), into the expansion device (such as coiled capillary tube) (62). If the measured temperature at the temperature sensing means, (49), is greater than the target reference temperature, then the control system module (60) will increase the working fluid inlet mass flow rate (as detected by the flow meter (9)) by opening valve (52).

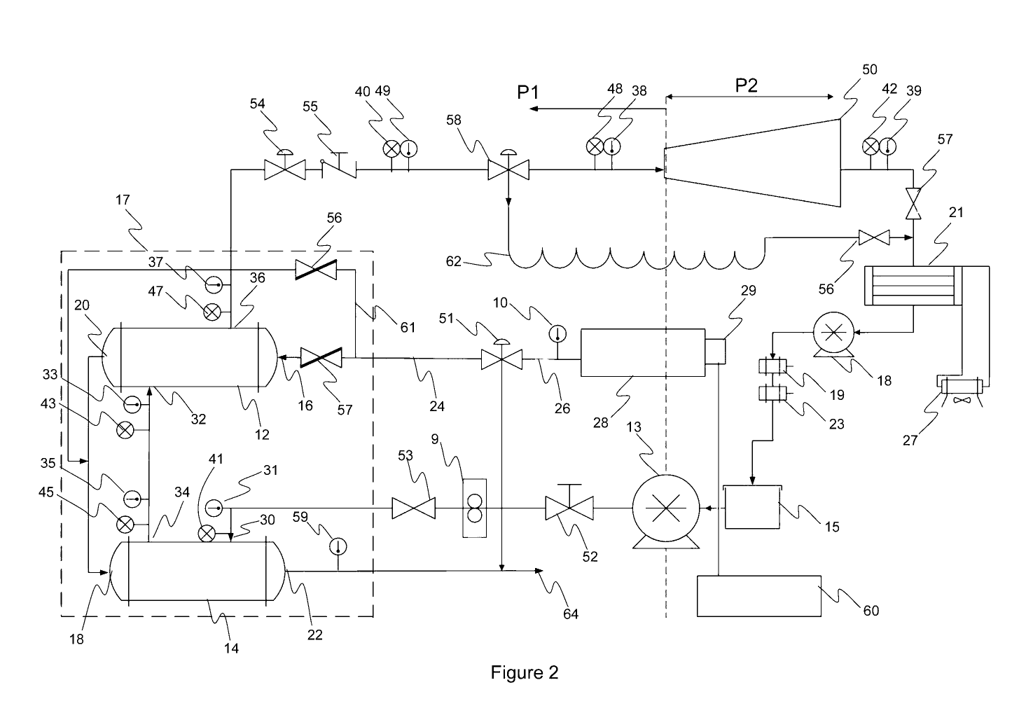

With respect to the system in FIG. 2, a parallel configuration of heat exchangers, the engine (28) has a load sensor (29) and a control system module (60) receives data from the load sensor (29).

In addition, temperature sensing means, (31) and (37), are located close to the working fluid inlet (30) and outlet (36) openings of the heat collecting circuit (17).

The control system module (60) is in communication with these temperature sensing means, (31) and (37), to receive working fluid temperature related information. Additional working fluid temperature related information is obtained from the temperature sensing means, (35), (33), (49), and (38), and received by the control system module (60). A further temperature sensing means (59) is located on the exhaust conduit and exhaust temperature data is then relayed to the control system module (60).

As a person skilled in the art would appreciate, the temperature sensing means can be connected to the control module (60) in a number of ways to allow transfer of temperature data from the temperature sensing means to the control module. The same can be said for both pressure sensing means and flow measuring means, both of which are known to those skilled in this field.

When the engine (28) is running, engine operating variables, including engine load, engine speed, mass flow of air and fuel are then relayed to the control systems module (60), along with exhaust temperature data from the temperature sensing means (59). The engine heat recovery algorithm then determines the optimum working fluid pressure and inlet mass flow rate through the inlet port (30) of the system.

Once the optimum pressure has been determined, then the control system module (60) measures the temperature of the fluid at the temperature sensing means, (35) and (37), to provide temperature data T₁ and T₂ which are compared with the reference temperature for optimum working pressure provided by the heat recovery algorithm. If T₁ and T₂ is less than the reference temperature, the control system module (60) operates to decrease the working fluid inlet mass flow rate (as detected by the flow meter (9)) through the valve (52). If T₁ and T₂ are greater than the reference temperature then the control system module (60) operates to increase the working fluid inlet mass flow rate (as detected by the flow meter (9)) through the valve (52).

The control system module (60) may also be operatively connected to the pump (13) so as to regulate the action of the pump (13) to control the working pressure of the working fluid within the heat collecting circuit (17).

Based on an optimum pressure, determined by the engine heat recovery algorithm, control valves (56) and (57) can be operated by the control system module (60) to direct the exhaust gas travelling through the exhaust conduit (24) either into the first heat exchanger (12) or by directing the waste exhaust gas, or at least a portion thereof, through the bypass section or waste exhaust bypass line (61), directing the waste exhaust gas into the second heat exchanger (14). When the exhaust gas is directed through the first heat exchanger (12) and then directly into the second heat exchanger (14), this is referred to as a series arrangement (as seen in FIG. 1). When a portion of the exhaust gas is directed through the bypass section or exhaust bypass line (61) into the second heat exchanger (14), this is referred to as a parallel arrangement.

It should be noted that it is contemplated within the scope of the invention that the amount of exhaust gas being directed through the bypass section (61) can range from 0 to 100%. When 100% of exhaust gas is directed through the bypass section (61) into the second heat exchanger (14), closing the valve (57), the arrangement is neither in parallel or series but rather just relying on a single heat exchanger arrangement. Depending upon the operating conditions determined using the engine heat recovery algorithm, and its associated engine mapping, 100% of exhaust gases may be directed in this manner.

If the optimum pressure, measured by the pressure sensor (41) is below or above a pre-defined pressure, the control system module (60) controls the valves, (56) and (57), to determine an exhaust gas splitting ratio. For example, if the optimum pressure at 40% load is 15 bar, then the control valves, (56) and (57), operated by the control system module (60) will adjust the first and second heat exchangers (12) and (14) to be in parallel arrangement and determine the mass fraction of exhaust. Approximately 60% of the exhaust mass flow will then be directed to enter the first heat exchanger (12) via the inlet port (16), the remaining approximately 40% of the exhaust mass flow is then directed through the bypass section (61) to mix with the exhaust gas as it exits through outlet port (20) of the first heat exchanger (12) and then enters into the second heat exchanger (14) by the inlet valve (18).

For the example of a 40% bypass, the exhaust ratio determined at the control valves, (56) and (57), can be varied then by the control system module (60) as required by engine variables including, but not restricted to, engine load and exhaust temperature for parallel arrangement of the heat exchangers, conditional upon the calculated engine heat recovery algorithm. The exhaust ratio will vary according to the heat recovery algorithm for different speeds and loads of the engine.

By recovering waste heat, a Rankine Cycle is run to generate additional power. Rankine Cycle components include the turbine (50), turbine generators, (19) and (20), one-way valves (56) and (57), pump (18), and condenser (21). In addition to the cooling components of the Rankine cycle are the condenser cooling circuit (27), and buffer tank (15).

In FIG. 2, P1 indicates high pressure and P2 is slightly above atmospheric pressure or vacuum pressure, as created by the vacuum pump (18). If no vacuum is required for the system, the vacuum pump (18) is not required.

As will now be seen, by use of the control system module, (60), and application of the engine heat recovery algorithm, which is optionally integrated with an engine management system for the engine, engine mapping against engine operating variables and energy generation data from the electrical generator can now beneficially optimise the generation of electricity dependent upon the engine operating variables as well as optimise the running of the internal combustion engine producing the waste exhaust gas so as to suit a desired operation.

What is claimed is:

1. A waste heat recovery system for use with an internal combustion engine,
including
at least a first heat exchanger and a second heat exchanger;
an exhaust conduit for receiving an input of waste exhaust gas flow from the internal combustion engine;
a working fluid configured to absorb thermal energy;
a heat collecting circuit operatively connected to the first heat exchanger and the second heat exchanger to transfer heat energy from the waste gas exhaust flow to the working fluid;
wherein the working fluid is first directed to the second heat exchanger then directed to the first heat exchanger, the first heat exchanger being positioned upstream, with respect to the waste exhaust gas flow, of the second heat exchanger; and
a turbine operatively connected to the heat collecting circuit, and operatively connected to an electrical generator,
a working fluid control means to control the flow of working fluid into the second heat exchanger;
the working fluid control valve being operatively connected to a control module, said control module capable of controlling the operation of the working fluid control means in response to a variable of at least one variable of the waste heat recovery system, the internal combustion engine or the electrical generator.

2. The waste heat recovery system of claim 1, wherein the exhaust conduit includes an exhaust control valve for diverting selectively exhaust gas away from the first heat exchanger and to the second heat exchanger.

3. The waste heat recovery system of claim 1, including an waste exhaust bypass line connected to the exhaust conduit at a first end and to the second heat exchanger at a second end and having an exhaust bypass control valve to selectively control the flow of exhaust gas bypassing the first heat exchanger into the second heat exchanger.

4. The waste heat recovery system of claim 1, wherein the variable of the waste heat recovery system is a variable of the working fluid of a working fluid pressure and/or working fluid temperature.

5. The waste heat waste heat recovery system of claim 1, wherein the variable is a variables selected from engine temperature, engine load, exhaust gas temperature, engine fuel flow rate, oxygen concentration in the exhaust flow, engine fuel economy.

6. The waste heat waste heat recovery system of claim 1, wherein the variable is a variable from the electrical generator being the, amount of energy generated by the electrical generator.

7. The waste heat waste heat recovery system of claim 1, wherein the working fluid control means is a flow control valve.

8. A method of operating an internal combustion engine having a waste heat recovery system of claim 1, wherein the method comprises the steps of:
measuring at least one variable (V1) of the working fluid configured to absorb thermal energy as it exits the first heat exchanger;
measuring at least one variable (V2) of the working fluid configured to absorb thermal energy as it exits the second heat exchanger;
determining and comparing, via an engine heat recovery algorithm within the electronic control module, V1 and V2 with a predetermined set of values and controlling the working fluid control valve based on said comparison.

9. A method of operating an internal combustion engine having a waste heat recovery system of claim 1 that further includes an waste exhaust bypass line connected to the exhaust conduit at a first end and to the second heat exchanger at a second end and having an exhaust bypass control valve to selectively control the flow of exhaust gas bypassing the first heat exchanger into the second heat exchanger, wherein the method comprises the steps of:
measuring at least one variable (V1) of the working fluid configured to absorb thermal energy as it exits the first heat exchanger;
measuring at least one variable (V2) of the working fluid configured to absorb thermal energy as it exits the second heat exchanger;
determining and comparing, via an engine heat recovery algorithm within the electronic control module, V1 and V2 with a predetermined set of values and controlling exhaust bypass control valve based on said comparison.

10. The method of claim 8, wherein the at least one variable is selected from the group of working fluid pressure and/or working fluid temperature.

11. The method of claim 10, wherein the predetermined set of values is selected from fuel economy of the internal combustion engine and/or energy generated from the electrical generator.

12. The method of claim 9, wherein the at least one variable is selected from the group of working fluid pressure and/or working fluid temperature.

13. The method of claim 12, wherein the predetermined set of values is selected from fuel economy of the internal combustion engine and/or energy generated from the electrical generator.
